(19) United States
(12) Patent Application Publication
(10) Pub. No.: US 2007/0138786 A1
(43) Pub. Date: Jun. 21, 2007

(54) Event reminder method and system

(76) Inventor: Jhon Singleton, Garden City, NY (US)

Correspondence Address: HESLIN ROTHENBERG FARLEY & MESITI PC, 5 COLUMBIA CIRCLE, ALBANY, NY, 12203, US

(21) Appl. No.: 11/316,563

(22) Filed: Dec. 21, 2005

(51) Int. Cl. B42D 5/04

(52) U.S. Cl. 283/2

(57) ABSTRACT

A means for reminding a person of upcoming events, made from a sheet having designations, denoting possible months in a given year, possible days in a given month, day in a week, and designations representing the time period when an event is expected to occur. The object of the invention is to provide an expedient and efficient way for a person to save and record an upcoming event through marking a sheet with all relevant date and time information, thereby eliminating the need to print or write this data.

### TECHNICAL FIELD

The present invention generally relates to a novel means for efficiently recording and reminding a person of an upcoming event. More particularly, the present invention relates to a system and method for recording the months, dates, days, and times of upcoming events or occurrences, allowing the user to mark the desired month, date, day, and time, of events, from a list of the possible calendar dates, days, months, and times, without the need to write out that information by hand or machine.

### BACKGROUND OF THE INVENTION

There have been a number of reminder devices that have been developed for the purpose of recording an upcoming event. For example, U.S. Pat. Nos. 4,178,019, 4,218,077, 5,029,903, 5,352,152, depict such devices.

For instance in U.S. Pat. No. 4,178,019, issued to Gedzelman, discloses a calendar dependant on being embodied as a stacked sheet to operate.

The invention disclosed in U.S. Pat. No. 4,218,077 issued to Ember, discloses use of a calendar for storing upcoming appointments, requiring the user to write down upcoming appointments on the device.

Another invention U.S. Pat. No. 5,029,903, issued to Pennock, discloses a note-pack useful for storing information, which does not provide a method for concisely storing upcoming events.

A further example is provided in U.S. Pat. No. 5,352,155, issued to Fahey, which discloses use of an appointment reminder for use by a service-provider containing a base-card and removable label. This reminder enables a person to create a dual impression reminder for an upcoming event, where one impression may be removed and placed elsewhere. Use of this reminder requires that the person using it circle or mark, both a category denoting whether the event occurs in either the A.M. or P.M. (circling or marking, both a base card and the removable card) and additionally, the person must circle or mark the pertinent day of the week designating when the event will happen. However, in using this reminder the user is nevertheless forced to write out the month, day, and time, representing the date and time when the event will occur.

Thus, a need exists for a means to record an upcoming event without requiring the user to write or type any of the relevant data to represent the date and time of said event.

### SUMMARY OF THE INVENTION

Briefly, the present invention satisfies the need for an appointment reminder that may be utilized to record an upcoming event solely by marking the relevant date and time period without the need to write any of the date and time information by hand or machine.

In accordance with the above, it is an object of the present invention to provide a means for a person to record the date and time of an event by simply marking the relevant date and time periods, thereby saving the user time and effort.

The present invention provides, in a first aspect, a sheet having a face. The face further has: a first set of designations representative of months of the year; a second set of designations representing the days of a month of the year; a third set of designations representing the days of a week; a fourth set of designations representing the hours of a day; and a marking area to indicate an event. To use the invention the user marks the said first, second, third, and fourth designations to represent the date and time of a particular event.

The present invention provides, in a second aspect, a system for reminding a person of an upcoming event. This system comprises: a sheet having a face; a first set of designations on said face representative of months of the year; a second set of designations on said face representing the days of a month of the year; a third set of designations on said face representing the days of a week; a fourth set of designations on said face representing the hours of a day; an area on said face being markable by a person to indicate an event. To use the system a person marks the first, second, third, and fourth designations on the face to represent the date and time of said event and as needed the markable area.

These, and other objects, features and advantages of this invention will become apparent from the following detailed description of the various aspects of the invention taken in conjunction with the accompanying drawings.

### BRIEF DESCRIPTION OF THE DRAWINGS

FIG. 1 depicts a top-view of the invention, displaying the face of an individual sheet and the said designations used to denote the date and time.

FIG. 2 illustrates a perspective view of the invention, utilizing an embodiment wherein a plurality of individual sheets are stacked above one-another.

FIG. 3 is a side-view of the invention, which provides a side-view of the embodiment in FIG. 2, having a plurality of individual sheets stacked above one-another.

FIG. 4 depicts an embodiment of the invention, similar to the other embodiments, but additionally providing a means for recording the year of an upcoming event.

FIGS. 5-7, are generally similar to the other displayed embodiments, but alternatively depict embodiments wherein the relevant month, date, day, and time are displayed in a language other than English, in this case the Spanish, Chinese, and French languages; however, the invention is in no way limited to a particular language.

### DETAILED DESCRIPTION OF THE INVENTION

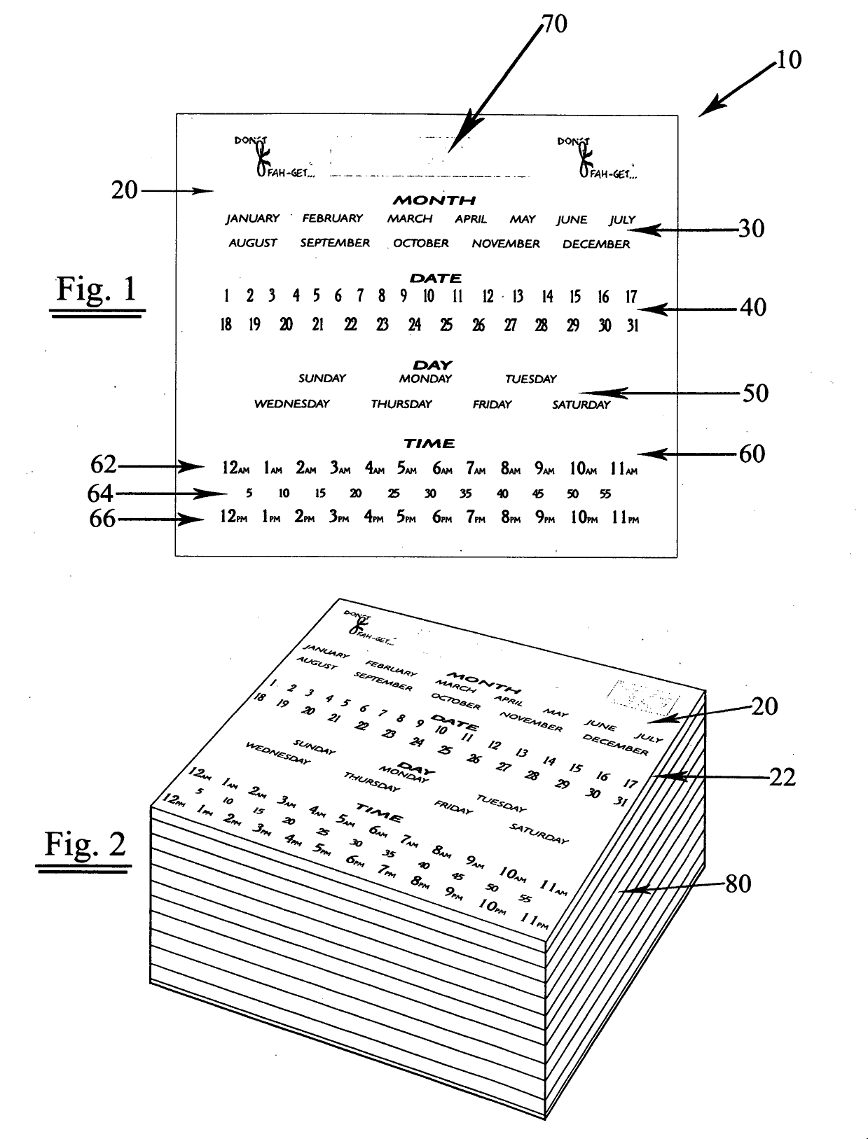

FIGS. 1-4, show several embodiments of the invention. FIG. 1, (10) shows a sheet from the reminder system. The face (20) of the sheet features designations representing the months of a year (30), the possible days of a month (40), the days of the week (50), and finally the time (60). Additionally, the face (20) in relevant part for recording date and time information, in addition to a portion, which may be utilized for storing information about the event, is made from a material suitable for being marked on by a user, such as paper. The term sheet may also be a computer screen or portion thereof, where said face would be displayed to the user via the screen or some other human machine interface device.

The months of the year (30) are shown written from January through December. Additionally the days available in a given month (40) are shown listed from 1 through 31, giving the user a choice of any possible day for marking an event in the intended month. The designation representing, day of the week (50) is broken down into days Monday through Sunday.

The time in this particular embodiment is broken down into designations representing the possible A.M. (62) and P.M. (66) time periods, in addition to designations representing finite minute intervals (64), in this particular case the minute periods broken down into five-minute intervals (64). It should be noted that a number of other time intervals, for example, 10, 15, 20, or 30-minute intervals, besides the five-minute intervals shown in the drawings (64), may be used.

Finally the face (20) features a markable portion suitable for recording a mark or note, descriptive of the intended event (70). Additionally, the entire sheet may be manufactured so that it is markable over its entire face and surface, if this feature is desirable to the user.

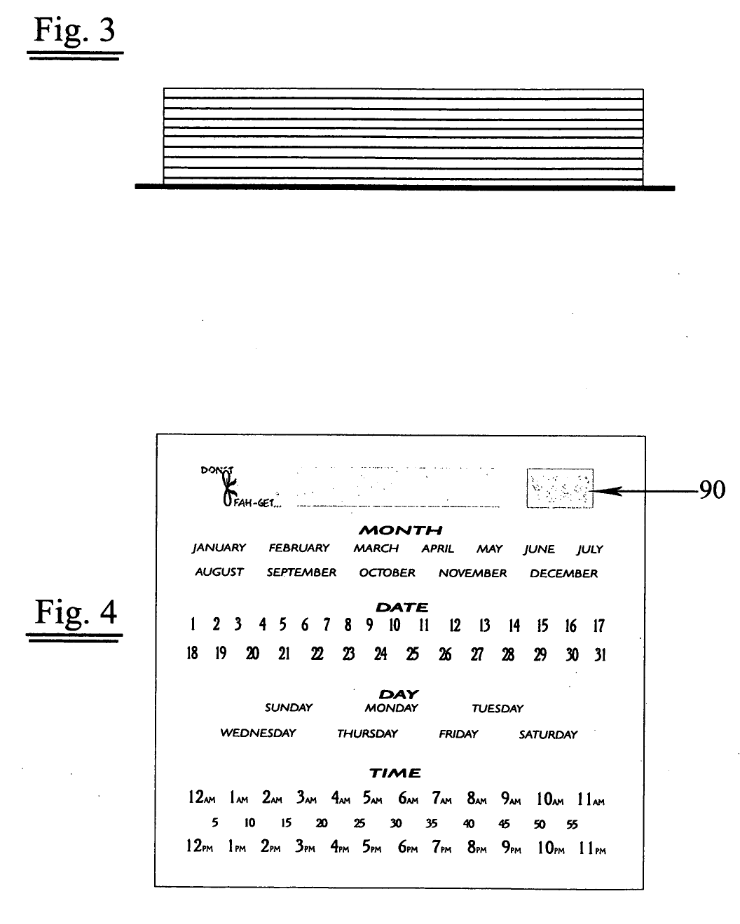

FIG. 2, shows the preferred embodiment of the reminder, in which, a plurality of the reminder sheets described in FIG. 1, are stacked vertically above one another (80), forming a device resembling a pad. In this embodiment an adhesive may be used to attach individual sheets (22) to one another. Ideally the adhesive would be of a releasable type allowing the individual sheets (22) from the plurality of stacked sheets (80) to be peeled-off, in the same way one would remove a note from a self-stick note pad, or otherwise removed from one-another as needed. This could be accomplished through use of an adhesive, which allows the individual sheets (22) to be releasably attached to other objects following removal from the plurality of other sheets. This would be desirable in that it would enable the user to place the removed sheet in a location convenient for reminding them self or another of recorded events. FIG. 3, again shows this embodiment, depicted in a side view.

It should further be noted that in other embodiments, individual sheets may also utilize an adhesive, despite not originating from a plurality of stacked sheets.

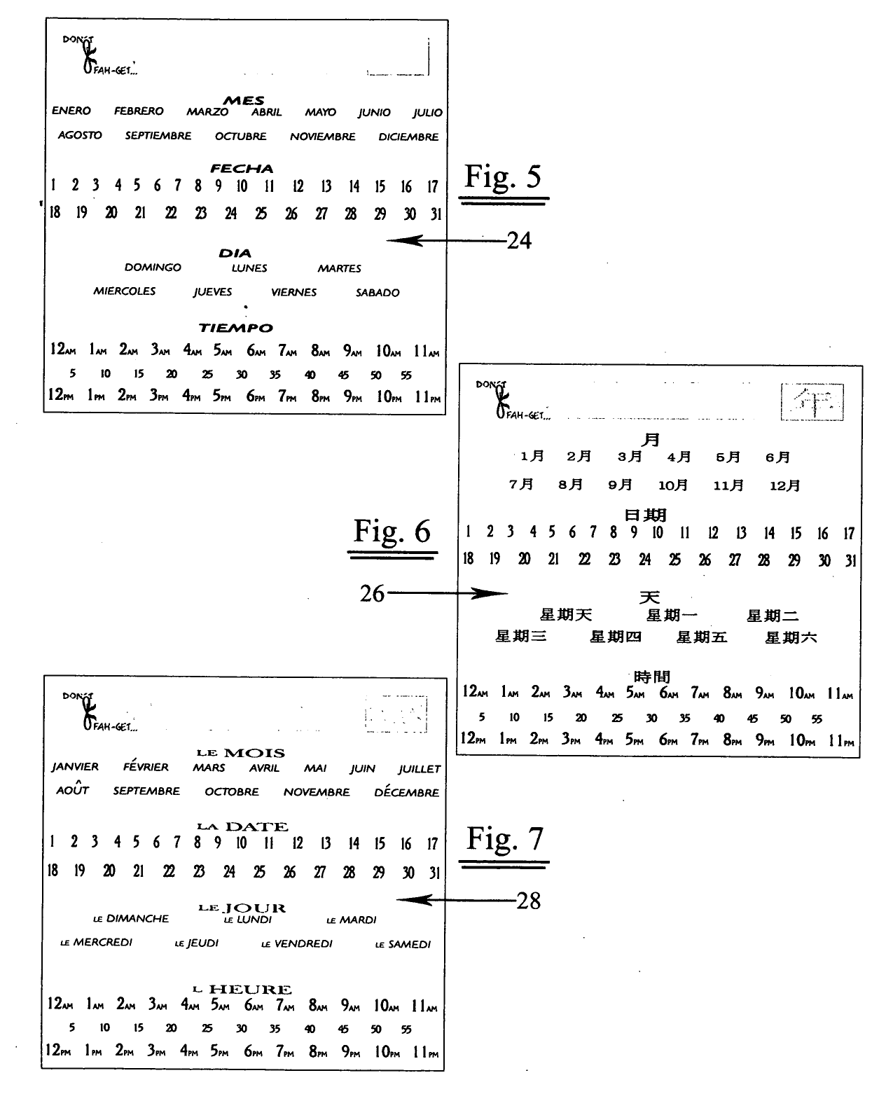

FIGS. 5-7, disclose embodiments of the reminder otherwise similar to those in FIGS. 1-4, except that they disclose a reminder utilizing a face (24, 26, 28) having designations written in a language other than English. In this case, FIGS. 5-7 depict the face in the Spanish, Chinese, and French languages respectively, although alternative forms of this embodiment may be provided in any written language that features a means for designating the date and time.

It should also be noted that if needed the design of the face (20) or (24, 26, 28) may be modified to incorporate an additional designation denoting the year in which an event may occur such as when a user wishes to record an event scheduled to occur in a subsequent year beyond the current one. FIG. 4, denotes one means for recording an event taking place during a subsequent year, wherein an additional markable space (90) is provided enabling the user to record the year in which an event is scheduled.

An example of how the reminding method could be used is demonstrated by a hypothetical person wishing to remind himself of an upcoming dinner appointment at a restaurant. To remind himself of the appointment the person would either obtain or have provided to him a sheet (10) similar to that disclosed in FIG. 1. One way to begin using the method would be to first write, type, or otherwise record information, on the markable area (70), to indicate the restaurant where the dinner plans were made. After indicating the location where the user planned to have dinner. The user would then proceed to designate, either by circling, highlighting, or otherwise marking over or through the month on which the dinner plans were expected to occur, using the portion of the face (20) representing the possible months of the year (30), this mark could be applied in a manner as simple as circling or crossing-out the appropriate month with a pen or pencil. The user would then proceed to designate, for example, by circling or crossing-out the appropriate day of the month on which the appointment was made, on the portion of the face (20) representing the days of a month of the year (40). Following this, the user would then, designate by, for example, by circling or crossing-out the day of the week, on which dinner was planned, on the portion of the face (20) representing the days of a week (50). Finally, the user would record the time of the event by marking the appropriate hour, for example, by circling or crossing-out, the hour for which the dinner plans were set, on the portion of the face (20) representing the hours of a day (60). If needed, the user would then proceed to designate the time to the nearest minute interval on the portion of the face (20) representing minute intervals (64), for example, by circling or crossing-out the minute-interval closest to the time of the dinner appointment. This would be particularly useful if for example the dinner plans were not set to begin on the top of the hour. In the reminder of FIG. 1, these plans could accurately be recorded down to a five-minute interval (64), although other embodiments could as easily use any of the other previously mentioned intervals, such as a 10, 15, 20, or 30-minute intervals. Thus, the user would now have a useful reminder of the location, time, and date of his upcoming dinner plans. Additionally, if the user chose to utilize one of the disclosed embodiments having a releasable adhesive, they could then post the reminder in a location, where they are likely to frequently notice it, further enhancing its effect on reminding them. Once the reminder was no longer needed, the user could then simply peel-off and remove the reminder from the location where it was placed, in the same way that a person removes a self-stick note, and discard it.

Another example of using the method would be demonstrated by a hypothetical user wishing to remind him or herself of an upcoming doctor's appointment or perhaps an appointment to have their automobile serviced. A service-provider, may also wish to utilize the method so as to remind either them self, a customer, or an employee of upcoming obligations and/or expected events. These appointment examples and many other events, for which a person needs to be reminded of, could efficiently be recorded using the above method. Additionally, these and similar events could be recorded using, a system in accordance with the present invention, including a variety of other applications including but not limited to: address books, appointment books, appointment cards, business cards, business card holders, folders, non-adhesive note pads, memo-pads, spiral note books & note pads, office & school memo boards, blackboards, pocket planners, and schedule books, pads, planners, notebooks, computers, and computer software.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

I claim:

1. A method for reminding a person of an upcoming event, the method comprising:
providing a sheet having a face;
providing a first set of designations on the face representative of months of the year;
providing a second set of designations on said face representing the days of a month of the year;
providing a third set of designations on said face representing the days of a week;
providing a fourth set of designations on said face representing the hours of a day;
providing an area on said face being markable by a person to indicate an event; and
wherein said first, second, third, and fourth designations on said face are markable by a person to represent the date and time of said event.

2. The method of claim 1, further comprising, providing an additional set of designations on said face representing minute intervals within an hour, thereby enabling the user to mark a designation representing the approximate minute interval closest to when said event is expected to begin.

3. The method in claim 2, further comprising: providing adhesive on said sheet.

4. The method in claim 3, wherein the said providing adhesive, further comprises an adhesive, which is releasably adhesive to objects, thereby permitting the sheet to be removed, replaced, reattached, or attached to another object.

5. The method in claim 4, further comprising: stacking a plurality of the said sheets in a manner to allow the plurality of sheets to be stacked above one-another, thereby allowing the individual sheets to be peeled off of one another or otherwise separated from one another as required by the user.

6. A method of reminding a person of an upcoming event comprising:
obtaining a sheet having a face, a first set of designations on said face representative of months of the year; a second set of designations on said face representing the days of a month of the year; a third set of designations on said face representing the days of a week; a fourth set of designations on said face representing the hours of a day;
marking an area on said face to indicate an event; and
marking said first, second, third, and fourth designations to represent the date and time of said event.

7. The method of claim 6, further comprising, obtaining a sheet having, a fifth set of designations on said face representing the minute of an hour, thereby allowing the marking of this fifth designation in conjunction with the said first, second, third, and fourth designations to more accurately represent the time of said event.

8. The method in claim 7, further comprising: use of a said sheet having adhesive.

9. The method in claim 8, wherein said sheets having adhesive comprise a plurality of said sheets having adhesive, further comprising the plurality of said sheets having adhesive stacked above one another.

10. The method in claim 8, further comprising: use of a said sheet having adhesive applied on the side of the said sheet that is the reverse side of the side having said designations.

11. The method in claims 10, wherein said adhesive further comprises: an adhesive releasbly adhesive to other objects.

12. The method in claim 11, further comprising: stacking a plurality of the said sheets in a manner to allow the plurality of sheets to be stacked above one-another in such a way that individual sheets may be peeled-off or otherwise separated from one another as required by the user.

13. A system for reminding a person of an upcoming event comprising:
a sheet having a face;
a first set of designations on said face representative of months of the year;
a second set of designations on said face representing the days of a month of the year;
a third set of designations on said face representing the days of a week;
a fourth set of designations on said face representing the hours of a day;
an area on said face being markable by a person to indicate an event; and
said first, second, third, and fourth designations on said face are markable by a person to represent the date and time of said event.

14. The system in claim 13, further comprising, a fifth set of designations on said face representing the minutes of an hour, wherein first, second, third, fourth, and fifth designations on said face are markable by a person to represent the date and time of said event.

15. The system in claim 14, wherein said sheet further comprises: a plurality of said sheets comprising a pad.

16. The system in claim 14, wherein at least one side of said sheet further comprises an adhesive.

17. The system in claim 16, wherein the said adhesive further comprises: an adhesive, which is releasably adhesive to objects, permitting the sheet to be removed, replaced, reattached, or attached to another object.

18. The system in claim 17, wherein a plurality of the said sheets are stacked in a manner to allow the plurality of sheets to be stacked above one-another, permitting a user to remove individual sheets from the stacked plurality of said sheets as desired.

19. The system in claim 18, wherein the relevant month, date, day, and time is displayed in any language other than English.
